(19) United States
(12) Patent Application Publication
(10) Pub. No.: US 2003/0233424 A1
(43) Pub. Date: Dec. 18, 2003

(54) Instant messenger based interface apparatus in information apparatuses

(75) Inventor: Jang-seok Seo, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/357,345

(22) Filed: Feb. 4, 2003

(30) Foreign Application Priority Data
Jun. 12, 2002 (KR) 2002-32855

(51) Int. Cl. G06F 15/16

(52) U.S. Cl. 709/217

(57) ABSTRACT

Provided are an information apparatus capable of being controlled using an instant messenger (IM) and its system. In the information apparatus, which is controlled via a predetermined communication network, a driving unit drives the information apparatus. An IM-based interface unit receives a control command for the information apparatus from the communication network, and transfers state data representing the present state of the information apparatus or the function data representing the executable functions of the information apparatus through the communication network. An information apparatus controller receives the control command from the IM-based interface unit, drives the driving unit according to the control command, generates the state data by checking the current state of the driving unit, and transfers the state data to the IM-based interface unit.

### BACKGROUND OF THE INVENTION

1. Field of the Invention

The present invention relates to an information apparatus capable of being controlled by an instant messenger (IM) and its system.

2. Description of the Related Art

An instant messenger (IM) used in the specification will now be described. In an existing method of transmitting a message, such as short message service (SMS) or Email, a message from a message sender is stored on a server. Upon a request by a message receiver, the stored message is searched and transmitted to the message receiver. On the other hand, an IM enables two-way, real time message exchange between a message sender and a message receiver. An IM such as this is composed of an IM server, which is connected to a communication network, such as Internet, Firewall, or network address translation (NAT), and a pair or plurality of clients that are connected to the IM server through the aforementioned communication network. The IM server registers and manages buddy identifiers (IDs), which are the IDs of the clients connected to the IM server itself. The clients mutually transmit a message to each other via the IM server using their buddy IDs.

Home networking represents an environment created so that information apparatuses at home form a network to share digital data between them and broadband communication can be implemented. In such a home network, the current state of home appliances (information apparatuses), such as digital TVs, DVDs, or washing machines, is checked and controlled through portable information technology terminals (user terminals), such as cellular phones or PDAs, and home security is remotely checked through a monitoring camera to strengthen security.

In the prior art, in order to control the home appliances at home, first, a homepage must be made on the Internet, and then the home appliances must be registered on the created homepage. Under this environment, when there is a need to control the home appliances, a user connects to the homepage and controls them.

Consequently, only a terminal capable of connecting to a homepage, that is, personal computers (PC), can be utilized to control the home appliances at home according to the above-described prior art.

### SUMMARY OF THE INVENTION

To solve the above-described problem, it is an object of the present invention to provide an apparatus for controlling information apparatuses using an instant messenger (IM).

To achieve the above object, the present invention provides an information apparatus controlled via a communication network, such as the Internet. In the apparatus, a driving unit drives the information apparatus. An instant messenger (IM) based interface unit receives a control command with respect to the information apparatus from the communication network and transmits state data on the current state of the information apparatus and function data on the functions of the information apparatus, to the communication network. An information apparatus controller receives the control command from the IM based interface unit, drives the driving unit according to the control command, and checks the current state of the driving unit to generate the state data and outputs the state data to the IM based interface unit.

The IM based interface unit includes a messenger, a message analyzer, and a message generator. The messenger receives a message including the control command for controlling the information apparatus via the communication network and transmits the function data on the functions of the information apparatus, or the state data on the current state of the information apparatus to the communication network. The message analyzer extracts the control command from the message received from the messenger and sends the control command to the information apparatus controller. The message generator receives the state data or the function data from the information apparatus controller, generates a message corresponding to the received data, and provides the message to the messenger.

The information apparatus further includes an information apparatus state data storage unit for receiving the state data from the information apparatus controller and storing the state data.

To achieve the above object, the present invention also provides an IM based system for controlling an information apparatus using a user terminal via a communication network, such as the Internet. In the system, the information apparatus performs an IM function of transmitting or receiving an instant message via the communication network, transmits state data on the current state of the information apparatus itself or function data on the functions of the information apparatus itself to the user terminal using the IM function, receives a control command from the user terminal, and executes the control command. The user terminal performs an IM function of transmitting or receiving an instant message via the communication network, and receives the state data or function data and transmits the data to a user using the IM function. The user terminal also receives an apparatus control command from the user and transmits the information apparatus control command to the information apparatus.

### BRIEF DESCRIPTION OF THE DRAWINGS

The above object and advantage of the present invention will become more apparent by describing in detail a preferred embodiment thereof with reference to the attached drawings in which:

FIG. 1 shows a preferred embodiment of a home networking architecture for remotely controlling an information apparatus using an instant messenger (IM) based interface according to the present invention;

FIG. 2 is a block diagram of a preferred embodiment of the information apparatus 103 having an IM based interface apparatus according to the present invention;

FIG. 3 is a reference view for illustrating a process for registering a new information apparatus in the messenger of a user terminal according to the present invention;

FIG. 4 is a reference view for illustrating a process for controlling the operation of a washing machine, which is an example of an information apparatus, using a user terminal according to the present invention;

FIG. 5 illustrates a process for registering a buddy identifier (ID) between an information apparatus and a user terminal, according to the present invention; and

FIG. 6 illustrates a process for controlling an information apparatus through a user terminal, according to the present invention.

### DETAILED DESCRIPTION OF THE INVENTION

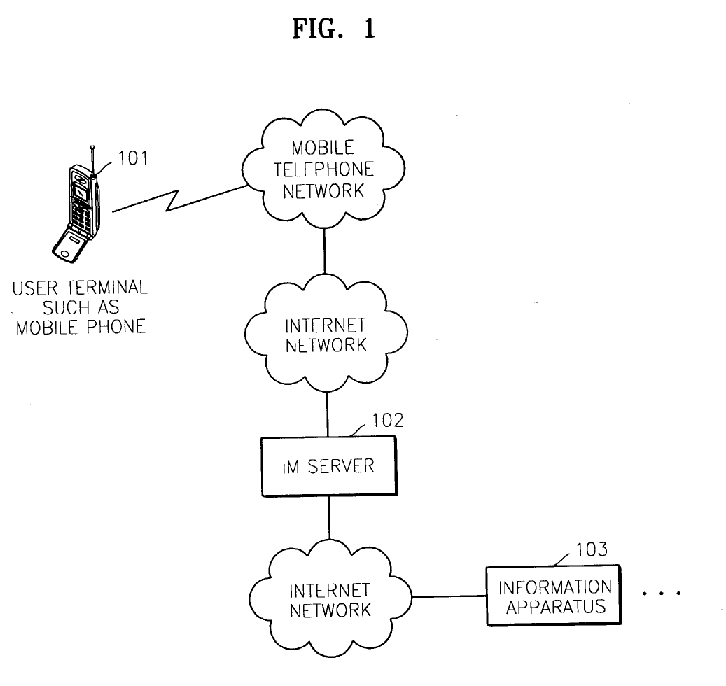

Referring to FIG. 1, in a home networking architecture according to the present invention, a user terminal 101 is connected to an Internet network through the Internet or a mobile telephone network and includes an instant messenger (IM). The IM registers an information apparatus 103 to transmit or receive necessary messages to or from the information apparatus 103. Here, the messages received from the information apparatus 103 can be the data relating to the functions of the information apparatus 103 or the data representing the current state of the information apparatus 103. If the information apparatus 103 is a washing machine, the functions of the information apparatus can correspond to various washing functions depending on the type of wash cycle, and the current state of the information apparatus can correspond to the progress in the wash cycle or whether or not the washing machine is connected to a communication network. The messages transmitted to the information apparatus 103 can be commands that control the information apparatus 103. If the information apparatus 103 is a washing machine, the commands can be a command starting the wash cycle, a command stopping the wash cycle, and the like.

The user terminal can be a mobile phone, a PDA, or a PC, each having a messenger function.

An IM server 102 relays messages between the user terminal 101 and the information apparatus 103 using the messengers installed in and driven by them, respectively. The IM server 102 performs the same function as that of a conventional IM server.

The information apparatus 103 indicates an apparatus remotely controlled through a communication network, for example, a variety of home appliances, such as a washing machine, an air conditioner, or the like. The information apparatus 103 is connected to a communication network, such as the Internet, and includes an IM.

The IM registers the user terminal 101 to transmit or receive necessary messages to or from the user terminal 101. The messages exchanged between the information apparatus 103 and the user terminal 101 are the same as described above.

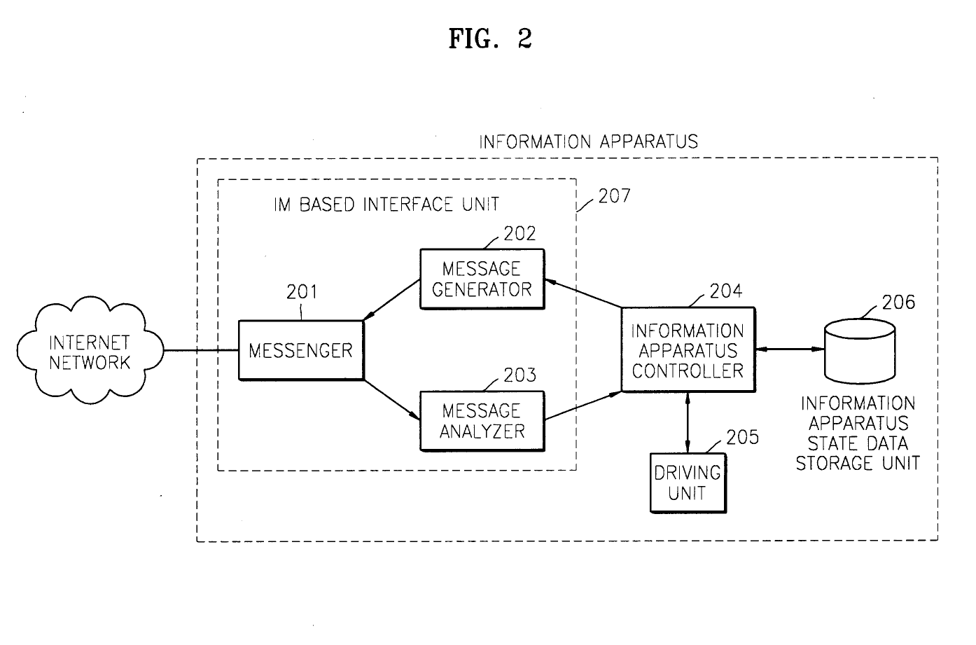

FIG. 2 is a block diagram of a preferred embodiment of the information apparatus 103 having an IM based interface apparatus according to the present invention. An IM based interface unit 207 according to the present invention is composed of a messenger 201, a message generator 202, and a messenger analyzer 203. The information apparatus according to the present invention includes the above-described IM based interface unit 207, an information apparatus controller 204, and a driving unit 205. In some cases, the information apparatus can further include an information apparatus state data storage unit 206.

The messenger 201 registers the user terminal 101 to control an information apparatus using an e-mail address or the like, and transmits a message received from the message generator 202 to the user terminal 101. The messenger 201 also receives a message including a control command (for example, a command starting a wash cycle if the information apparatus is a washing machine) from the user terminal 101 and sends the received message to the message analyzer 203.

The message generator 202 receives the data representing the current state of the information apparatus, or the data representing the function of the information apparatus, from the information apparatus controller 204, generates a message corresponding to the received data, and sends the message to the messenger 201.

The message analyzer 203 receives a message from the messenger 201, extracting the aforementioned control command by determining whether the received message includes or corresponds to the control command with respect to the information apparatus, and sends the extracted control command to the information apparatus controller 204. A determination of whether the received message includes the control command with respect to the information apparatus can be made by phrase comparison, in which a received message is compared with a previously registered phrase corresponding to the control command in order to check if the former is in accordance with the latter.

The information apparatus controller 204 checks the state of the driving unit 205 for performing the function of an information apparatus, for example, the motor for driving a washing machine if the information apparatus is a washing machine, generates data regarding the checked state, and sends the data to the message generator 202. Also, the information apparatus controller 204 controls the driving unit 205 according to the control command received from the message analyzer 203. In some cases, the information apparatus controller 204 can provide the data regarding the state of the driving unit 205 to the information apparatus state data storage unit 206 to store the state data.

In addition, the information apparatus controller 204 receives a user request for the function data regarding the functions of the information apparatus through the messenger 201 and the message analyzer 203, and sends the function data to the message generator 202.

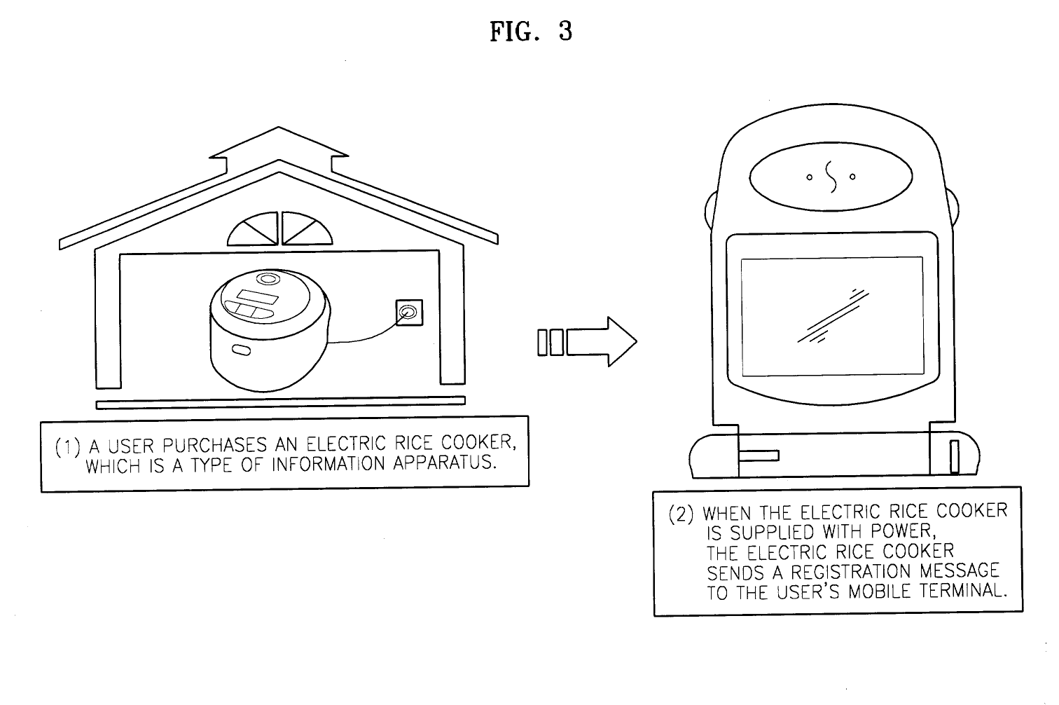

FIG. 3 is a reference view for illustrating a process for registering a new information apparatus in the messenger of a user terminal according to the present invention. First, a user purchases an electric rice cooker, which is a type of information apparatus. Then, an e-mail address or IP address associated with the mobile terminal of the user is registered in the messenger of the IM based interface apparatus in the electric rice cooker. Thereafter, power is applied to the electric rice cooker. Next, the IM based interface apparatus in the electric rice cooker sends a registration message to the user's registered mobile terminal.

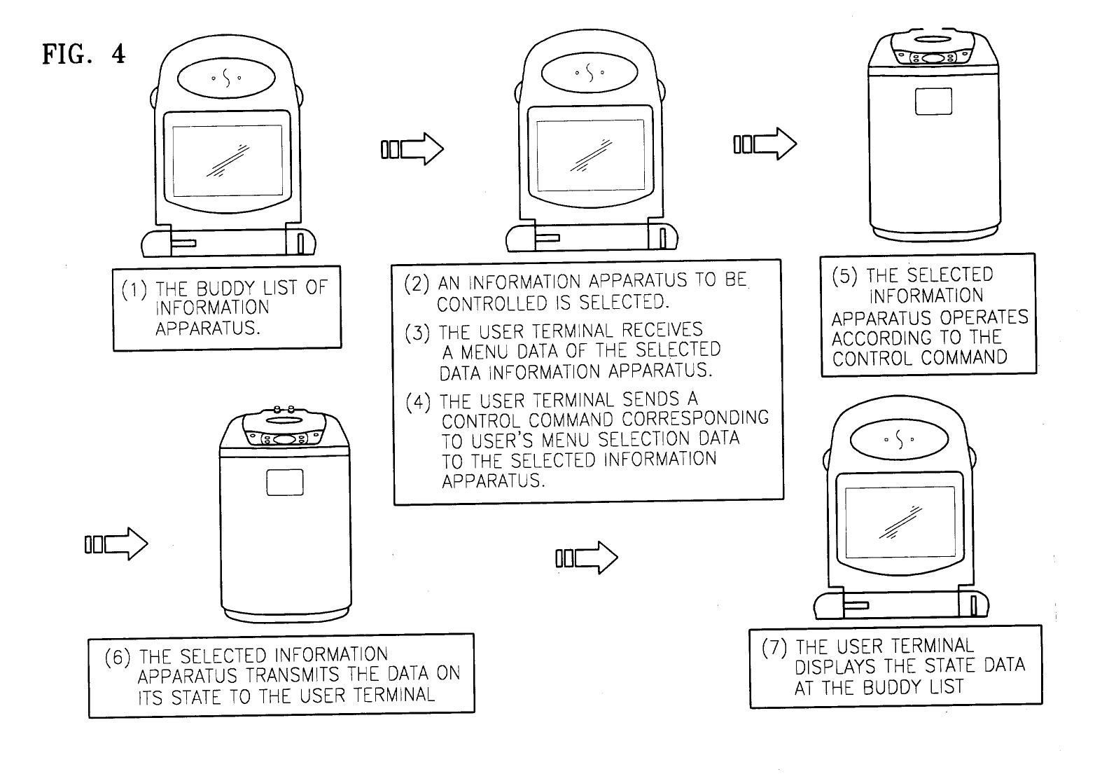

FIG. 4 is a reference view for illustrating a process for controlling the operation of a washing machine, which is an example of an information apparatus, using a user terminal according to the present invention. First, an apparatus, for example, a washing machine, is selected from the information apparatuses registered in a user terminal. Next, the messenger in the user terminal sends connection data to the messenger of the selected information apparatus, and the messenger of the information apparatus sends the state and menu data of the selected information apparatus to the user terminal. For example, the state data can be “In wash cycle”, and the menu data can be “1. washing, 2. rinsing, 3. spin-dry”. The user terminal having received the state data displays the state data on the user terminal.

When the user terminal receives a control command, for example, menu selection data, from the user, it transmits the received control command to the information apparatus. The information apparatus having received the control command operates according to the control command while transmitting the data on its state to the user terminal on a periodical basis or when it's state changes. The information apparatus can also transmit the state data to the user by displaying the state data on the user terminal.

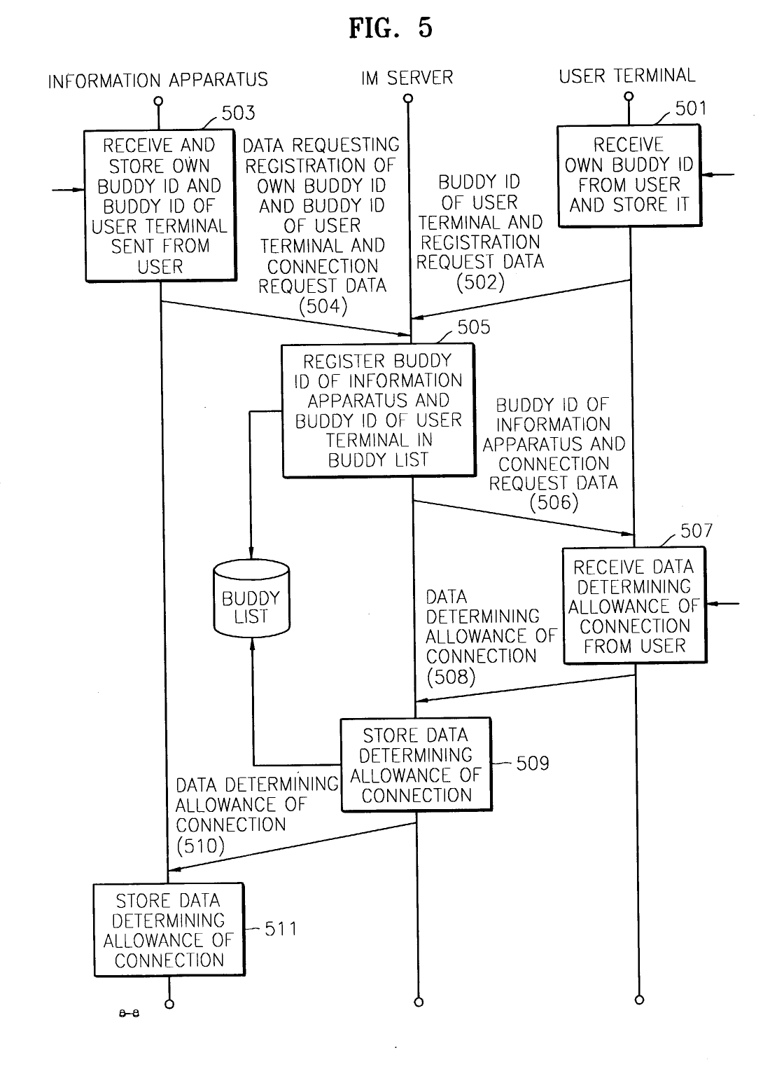

FIG. 5 illustrates a process for registering a buddy identifier (ID) between an information apparatus and a user terminal, according to the present invention. It is assumed that the information apparatus and user terminal of FIG. 5 each have an IM messenger.

First, the user terminal receives its own buddy ID from the user and stores it, in step 501. The received buddy ID of the user terminal and registration request data are transmitted to an IM server, in step 502.

In the meantime, the information apparatus receives and stores its own buddy ID and the buddy ID of the user terminal that is to be connected to the information apparatus itself and control it, in step 503. Next, the information apparatus transmits the data requesting that its own buddy ID and the buddy ID of the user terminal should be registered in a buddy list and the data requesting to be connected to the user terminal to the IM server, in step 504.

The IM server registers the buddy ID of the user terminal and the buddy ID of the information apparatus in the buddy list, in step 505. The IM server also transmits the buddy ID of the information apparatus and the connection request data to the user terminal, in step 506.

The user terminal notifies the user that it has received the buddy ID of the information apparatus and the connection request data and receives data from the user regarding whether the information apparatus should be connected to the user terminal, in step 507. The user terminal transmits the data relating to whether or not a connection should be made to the IM server, in step 508.

The IM server stores the received data regarding whether a connection should be made in the buddy list in connection with the buddy ID of the user terminal and the buddy ID of the information apparatus, in step 509. The IM server transmits the data regarding whether a connection should be made to the information apparatus, in step 510.

The information apparatus stores the received data regarding whether the information apparatus should be connected to the user terminal, in step 511.

Through this process, an information apparatus and a user terminal registers their buddy IDs in an IM server and can be connected to each other via the IM server.

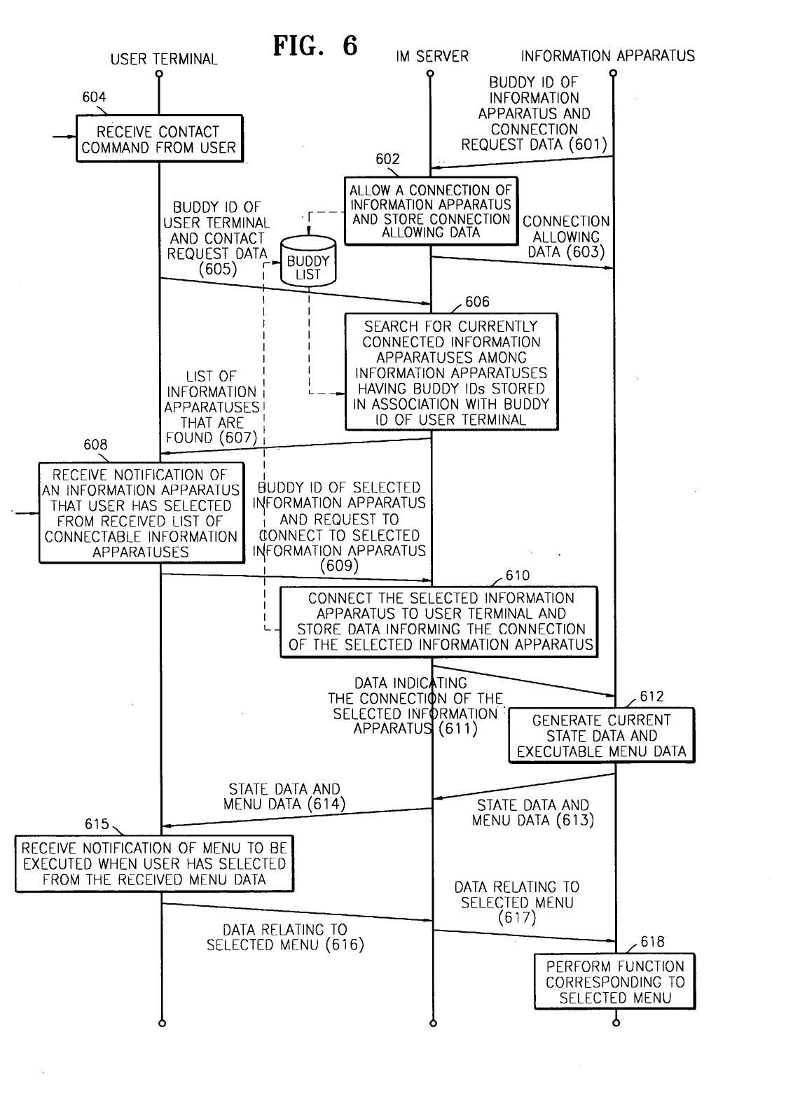

FIG. 6 illustrates a process for controlling an information apparatus through a user terminal, according to the present invention. It is assumed that the buddy ID of a user terminal and the buddy ID of an information apparatus have already been registered in an IM server through the process of FIG. 5.

First, the information apparatus transmits its own buddy ID and connection request data to the IM server, in step 601.

The IM server checks whether the received information apparatus buddy ID has been registered, which is not shown in FIG. 6. The IM server also allows a connection of the information apparatus and stores connection allowing data in a buddy list, in step 602. At this time, the connection allowing data can be transmitted to the information apparatus, in step 603.

A user terminal receives a command from a user to connect to the IM server, in step 604. The user terminal transmits the buddy ID of the user terminal and contact request data to the IM server, in step 605.

The IM server checks whether the buddy ID of the user terminal has been registered in the buddy list, which is not shown in FIG. 6. If the user terminal buddy ID has been registered, the information apparatuses having buddy IDs stored in association with the buddy ID of the user terminal are searched for information apparatuses currently connected to the IM server, in step 606. The IM server transmits a list of information apparatuses that are found to the user terminal, in step 607.

The user terminal receives notification of an information apparatus that the user has selected from the received list of connectable information apparatuses, in step 608. The user terminal transmits the buddy ID of the selected information apparatus and a request to connect to the selected information apparatus to the IM server, in step 609.

The IM server connects the user terminal to the selected information apparatus, in step 610. Then, the IM server transmits data informing that the selected information apparatus has connected with the user terminal to the information apparatus, in step 611.

The information apparatus receives the data informing that it has been connected to the user terminal, and generates state data regarding the current state of the information apparatus itself and menu data including executable menus, in step 612. Then, the information apparatus transmits the data to the IM server, in step 613. If the information apparatus is a washing machine, the state data can be “waiting”, “washing”, or “spin-dry”, and the menu data can be “1. washing, 2. spin-dry, etc.”.

The IM server receives the state data and the menu data from the information apparatus and transmits them to the user terminal, in step 614.

The user terminal outputs the received state data to the user and receives notification of a menu to be executed when the user has selected from the menu data, in step 615. The data relating to the selected menu is transmitted to the IM server, in step 616.

The IM server transmits the selected menu data to the information apparatus, in step 617. The information apparatus receives the selected menu data and performs the function corresponding to the received menu data, in step 618.

While this invention has been particularly shown and described with reference to a preferred embodiment thereof, it will be understood by those skilled in the art that various changes in form and details may be made therein without departing from the spirit and scope of the invention as defined by the appended claims.

In the present invention, when an information apparatus is managed by individual buddies of an instant messenger, and when the information apparatus is connected to a communication network, such as the Internet, a user can be automatically registered as a buddy. Thus, new information apparatuses are easily registered and managed.

A user can receive data on the state of the information apparatus at any time. In addition, the instant messenger is familiar to common users, since it is currently a well-known communication technique. Therefore, users can easily apply an information apparatus controlling method according to the present invention.

What is claimed is:

1. An information apparatus controlled via a communication network, the apparatus comprising:
a driving unit for driving the information apparatus;
an instant messenger (IM) based interface unit for receiving a control command with respect to the information apparatus from the communication network and transmitting state data on a current state of the information apparatus and function data on functions of the information apparatus, to the communication network; and
an information apparatus controller for receiving the control command from the IM based interface unit, driving the driving unit according to the control command, and checking the current state of the driving unit to generate the state data and output it to the IM based interface unit.

2. The apparatus according to claim 1, wherein the communication network is the Internet.

3. The information apparatus of claim 1, wherein the IM based interface unit comprises:
a messenger for receiving a message including the control command for controlling the information apparatus via the communication network and transmitting the function data on the functions of the information apparatus, or the state data on the current state of the information apparatus to the communication network;
a message analyzer for extracting the control command from the message received from the messenger and sending the control command to the information apparatus controller; and
a message generator for receiving the state data or the function data from the information apparatus controller, generating a message corresponding to the received data, and providing the message to the messenger.

4. The information apparatus of claim 1, further comprising an information apparatus state data storage unit for receiving the state data from the information apparatus controller and storing the state data.

5. An instant messenger (IM) based system for controlling an information apparatus using a user terminal via a communication network, the system comprising:
the information apparatus for performing an IM function of transmitting or receiving an instant message via the communication network, transmitting state data on its current state or function data on its functions to the user terminal using the IM function, receiving a control command from the user terminal, and executing the control command; and
the user terminal for performing an IM function of transmitting or receiving an instant message via the communication network, receiving the state data or function data and transmitting the data to a user using the IM function, and receiving an information apparatus control command from the user and transmitting the information apparatus control command to the information apparatus.

6. The system according to claim 5, wherein the communication network is the Internet.

7. A method of controlling an information apparatus using an instant messenger (IM), the method comprising:
a) at a user terminal having an IM, receiving a command from a user for controlling an information apparatus having an IM from a user, and transmitting the command to the information apparatus through an IM server; and
b) at the information apparatus, receiving the command through the IM server and performing the function corresponding to the command.

8. The method of claim 7, further comprising transmitting data on the result of the operation associated with the command or data on the current state of the information apparatus to the user terminal through the IM server by the information apparatus and outputting the data received through the IM server to the user by the user terminal.

9. The method of claim 7, before the command reception and transmission by the user terminal, further comprising:
transmitting a buddy identifier (ID) of the user terminal and a buddy ID of the information apparatus to the IM server and registering at least one of the buddy ID of the user terminal and the buddy ID of the information apparatus, in the IM server in connection with each other; and
connecting the user terminal to the information apparatus through the IM server and receiving data on the functions of the information apparatus from the information apparatus.

10. The method of claim 9, wherein the user terminal receives data on the functions of the information apparatus from the information apparatus.

11. A method of connecting an information apparatus to a user terminal using an instant messenger (IM), the method comprising:
(a) at the user terminal, receiving and storing a user terminal buddy ID and generating data requesting to register the user terminal buddy ID in an IM server;
(b) at the information apparatus, receiving and storing an information apparatus buddy ID and the user terminal buddy ID, which is to be used to connect to the information apparatus, and generating data requesting to register the information apparatus buddy ID in the IM server and data requesting to connect the information apparatus to the user terminal;
(c) at the IM server, receiving the user terminal buddy ID, the information apparatus buddy ID, the user terminal registration request data, and the information apparatus registration request data, registering the user terminal buddy ID and the information apparatus buddy ID in a buddy list of the IM server, and transmitting the information apparatus buddy ID and the connection request data from the information apparatus, to the user terminal;
(d) at the user terminal, outputting the connection request data received from the IM server, to a user, receiving data determining whether a connection should be made, and transmitting the data determining whether a connection should be made to the IM server; and
(e) at the IM server, receiving the data determining whether a connection should be made and reflecting the data determining whether a connection should be made in the buddy list.

12. The method of claim 11, further comprising, at the IM server, transmitting the data determining whether a connection should be made to the information apparatus and storing the data determining whether a connection should be made in the information apparatus.

13. A method of controlling an information apparatus using a user terminal, the method comprising:
(a) requesting a list of information apparatuses associated with a user terminal buddy ID from an instant messenger (IM) server that stores the user terminal buddy ID and buddy IDs of the information apparatuses associated with the user terminal buddy ID;
(b) outputting the information apparatus list from the IM server to a user and selecting an information apparatus from the information apparatus list;
(c) requesting the IM server to connect the user terminal to the selected information apparatus and connecting the user terminal to the selected information apparatus via the IM server;
(d) receiving menu data on the functions of the information apparatus via the IM server, providing the menu data to the user, and selecting a menu from the menus indicated by the menu data; and
(e) transmitting data on the function of the information apparatus corresponding to the selected menu to the information apparatus via the IM server and performing the function at the information apparatus.

14. The method of claim 13, wherein, in the step (b), the user selects an information apparatus from the information apparatus list.

15. The method of claim 13, wherein, in the step (d) and the step (e), state data related to the current state of the information apparatus is received via the IM server and transmitted to the user.

16. A method of operating an information apparatus according to a control command received from a user terminal via an instant messenger (IM) server, the method comprising:
(a) transmitting a preset buddy identifier (ID) of the information apparatus and the buddy ID of the user terminal to the IM server and registering the buddy ID of the information apparatus and a buddy ID of the user terminal in the IM server in connection with each other; and
(b) providing data on the functions of the information apparatus to the user terminal via the IM server and receiving and executing a command to perform at least one function of the information apparatus.

17. The method of claim 16, wherein, in the step (b), the information apparatus provides data on its functions to the user terminal via the IM server.

18. The method of claim 16, wherein the step (b) comprises:
receiving a command to transmit menu data representing said at least one function of the information apparatus from the user terminal via the IM server;
generating the menu data in accordance with the command and transmitting the menu data to the user terminal via the IM server; and
receiving data on a menu item selected from menus indicated in the menu data, by the user, from the user terminal via the IM server and performing said at least one function corresponding to the selected menu item.

19. A recording medium readable in a computer, wherein a program for operating the method of the claim 7 is recorded.

20. A recording medium readable in a computer, wherein a program for operating the method of the claim 11 is recorded.
